(19) United States
(12) Patent Application Publication
(10) Pub. No.: US 2025/0156754 A1
(43) Pub. Date: May 15, 2025

(54) COMPUTER SYSTEM AND METHOD FOR SEARCHING FOR BIAS REMOVAL METHOD

(71) Applicant: Hitachi Solutions, Ltd., Tokyo (JP)

(72) Inventors: Yuxin LIANG, Tokyo (JP); Masayoshi MASE, Tokyo (JP); Ryo SOGA, Tokyo (JP); Masashi EGI, Tokyo (JP); Hideto YAMAMOTO, Tokyo (JP); Naoya ISHIDA, Tokyo (JP)

(21) Appl. No.: 18/828,060

(22) Filed: Sep. 9, 2024

(30) Foreign Application Priority Data
Nov. 14, 2023 (JP) 2023-193681

(51) Int. Cl. G06N 20/00

(52) U.S. Cl. CPC G06N 20/00

(57) ABSTRACT

A computer system receives a request including information for specifying a business requirement, executes search processing for searching for a bias removal method used to generate an AI model that satisfies the specified business requirement, and generates a report including information on the bias removal method used to generate the AI model that satisfies the specified business requirement. In the search processing, processing of selecting the bias removal method and processing of executing learning processing of generating the AI model by using the selected bias removal method are repeatedly executed until the specified business requirement is satisfied.

### CLAIM OF PRIORITY

The present application claims priority from Japanese patent application JP 2023-193681 filed on Nov. 14, 2023, the content of which is hereby incorporated by reference into this application.

### BACKGROUND OF THE INVENTION

### 1. Field of the Invention

The present invention relates to a technique for removing a bias from an AI model.

### 2. Description of Related Art

In a field of machine learning, there is a method of generating an AI model using training data. It is known that in this method, since an objective variable included in the training data is given by a person, a deviation occurs in an output of the AI model generated using the training data to which a bias is applied.

As a method of removing the bias, there have been known methods disclosed in JP2023-113047A (Patent Literature 1) and Non Patent Literatures 1 to 4.

Non Patent Literature 1 discloses a method of rewriting an objective variable of training data. Non Patent Literature 2 discloses a method of rewriting a weight of learning of training data. Non Patent Literature 3 discloses a method of converting a feature. Non Patent Literature 4 discloses a method of adding a term of a bias index to a Loss function.

Patent Literature 1 discloses that “in the AI system, the control unit 115 includes a classification result acquisition unit that acquires a plurality of classification results of a plurality of pieces of data obtained by inputting each of the plurality of pieces of data into a machine learning model, an attribute identification unit that identifies, based on the plurality of classification results, a first plurality of attributes in which a difference in attribute value between a first plurality of pieces of data classified into a first group and a second plurality of pieces of data classified into a second group satisfies a standard among a plurality of attributes included in each of the first plurality of pieces of data and the second plurality of pieces of data among the plurality of pieces of data, a label determination unit that determines a label for each of the plurality of pieces of data based on a first index obtained by combining the first plurality of attributes, and a training unit that trains a machine learning model based on the determined label and the plurality of pieces of data.”

### CITATION LIST

### Patent Literature

Patent Literature 1: JP2023-113047A

### Non Patent Literature

[Non Patent Literature 1] Kamiran, Faisal, and Toon Calders. “Data preprocessing techniques for classification without discrimination.” Knowledge and information systems 33.1 (2012): 1-33.
[Non Patent Literature 2] Toon Calders, et. al “Building Classifiers with Independency Constraints”, ICDM2009
[Non Patent Literature 3] Zemel, Rich, et al. “Learning fair representations.” International conference on machine learning. PMLR, 2013.
[Non Patent Literature 4] Toshihiro Kamishima, Shotaro Akaho, Hideki Asoh & Jun Sakuma. “Fairness-Aware Classifier with Prejudice Remover Regularizer”, Machine Learning and Knowledge Discovery in Databases pp 35-50

### SUMMARY OF THE INVENTION

Applications of a bias removal method have the following issues.
(1) When the bias removal method is applied, the prediction accuracy of the AI model is reduced.
(2) When a certain bias removal method is applied, another improvement effect of the bias not considered in the bias removal method is unknown.

An item (feature) from which the bias is desired to be removed and a degree of bias removal are different depending on the business using the AI model. There are also various indexes for evaluating the bias removal.

An object of the invention is to implement a system and a method of searching for and presenting a bias removal method used for generating an AI model that satisfies a requirement (a business requirement) related to bias removal and prediction accuracy specified by a user.

A representative example of the invention disclosed in the present application is as follows. That is, a computer system includes a processor and a storage device connected to the processor, in which the storage device stores a data set including a plurality of pieces of training data including a plurality of features and an objective variable, business requirement definition information for storing a plurality of pieces of business requirement data defining a business requirement in a business using an AI model, and bias removal method management information for storing bias removal method data in which the feature of a bias removal target and a bias removal method for removing a bias of the feature are associated, the plurality of pieces of business requirement data include a plurality of pieces of first business requirement data including the feature of the bias removal target, a calculation method of a first index for evaluating a degree of bias removal, and a first business requirement defined by using the first index, and second business requirement data including a second index for evaluating a prediction accuracy of the AI model and a second business requirement defined by using the second index, the processor receives an AI model generation request including information for specifying at least one of the first business requirement and the second business requirement, executes, by using the data set, the business requirement definition information, and the bias removal method management information, search processing of searching for the bias removal method to be used for generating an AI model that satisfies the first business requirement and the second business requirement specified by the AI model generation request, and generates a report including information on the used bias removal method and outputs the report when the AI model that satisfies the first business requirement and the second business requirement specified by the AI model generation request is generated, and in the search processing, processing of selecting at least one of the bias removal methods and processing of executing learning processing of generating the AI model by using the selected bias removal method are repeatedly executed until the first business requirement and the second business requirement specified by the AI model generation request are satisfied.

According to the invention, it is possible to search for and present a bias removal method used for generating an AI model that satisfies a business requirement. Problems, configurations, and effects other than those described above will be clarified by description of the following embodiments.

### BRIEF DESCRIPTION OF THE DRAWINGS

FIG. 1 is a diagram illustrating a configuration example of an AI model generation system according to Embodiment 1.

FIG. 2 is a diagram illustrating an example of a hardware configuration of a computer implementing the AI model generation system according to Embodiment 1.

FIG. 3 is a diagram illustrating an example of a data structure of a data set according to Embodiment 1.

FIG. 4 is a diagram illustrating an example of a data structure of AI model information according to Embodiment 1.

FIG. 5 is a diagram illustrating an example of a data structure of AI model information according to Embodiment 1.

FIG. 6 is a diagram illustrating an example of a data structure of bias removal method information according to embodiment 1.

FIG. 7A is a diagram illustrating an example of a data structure of business requirement definition information according to Embodiment 1.

FIG. 7B is a diagram illustrating an example of the data structure of the business requirement definition information according to Embodiment 1.

FIG. 8A is a diagram illustrating an example of a data structure of an evaluation report according to Embodiment 1.

FIG. 8B is a diagram illustrating an example of the data structure of the evaluation report according to Embodiment 1.

FIG. 9 is a diagram illustrating an example of an input screen presented by the AI model generation system according to Embodiment 1.

FIG. 10 is a flowchart illustrating an example of processing executed by the AI model generation system according to Embodiment 1.

FIG. 11A is a flowchart illustrating an example of processing executed by the AI model generation system according to Embodiment 1.

FIG. 11B is a flowchart illustrating an example of the processing executed by the AI model generation system according to Embodiment 1.

FIG. 12 is a diagram illustrating an example of an output screen presented by the AI model generation system according to Embodiment 1.

FIG. 13A is a diagram illustrating an example of a data structure of business requirement definition information according to Embodiment 2.

FIG. 13B is a diagram illustrating an example of the data structure of the business requirement definition information according to Embodiment 2.

FIG. 14 is a flowchart illustrating an example of processing executed by an AI model generation system according to Embodiment 2.

FIG. 15 is a flowchart illustrating an example of an index conversion processing executed by a control unit according to Embodiment 2.

FIG. 16A is a flowchart illustrating an example of processing executed by an AI model generation system according to Embodiment 3.

FIG. 16B is a flowchart illustrating an example of the processing executed by the AI model generation system according to Embodiment 3.

FIG. 17 is a diagram illustrating an example of a business requirement pattern list according to Embodiment 3.

FIG. 18 is a diagram illustrating an example of a data structure of an evaluation report according to Embodiment 3.

FIG. 19 is a diagram illustrating an example of an output screen presented by the AI model generation system according to Embodiment 3.

FIG. 20 is a flowchart illustrating an example of business requirement selection processing executed by the AI model generation system according to Embodiment 3.

FIG. 21 is a flowchart illustrating an example of adjustment parameter setting processing executed by an AI model generation system according to Embodiment 4.

FIG. 22 is a flowchart illustrating an example of correlation analysis processing executed by an AI model generation system according to Embodiment 5.

FIG. 23 is a diagram illustrating an example of correlation coefficient information generated by the AI model generation system according to Embodiment 5.

FIG. 24 is a diagram illustrating an example of the correlation analysis information generated by the AI model generation system according to Embodiment 5.

### DESCRIPTION OF EMBODIMENTS

Hereinafter, embodiments of the invention will be described with reference to the drawings. However, the invention is not to be construed as being limited to the description of the following embodiments. It will be easily understood by those skilled in the art that the specific configuration can be changed without departing from the spirit or scope of the invention.

In the configurations of the invention to be described below, the same or similar configurations or functions are denoted by the same reference signs, and a redundant description will be omitted.

The notations “first”, “second”, “third”, and the like in the present specification are provided to identify components and do not necessarily limit the number or the order.

To facilitate understanding of the invention, the position, size, shape, range, and the like of each configuration illustrated in the drawings may not represent the actual position, size, shape, range, and the like. Therefore, the invention is not limited to the positions, sizes, shapes, ranges, and the like disclosed in the drawings.

### Embodiment 1

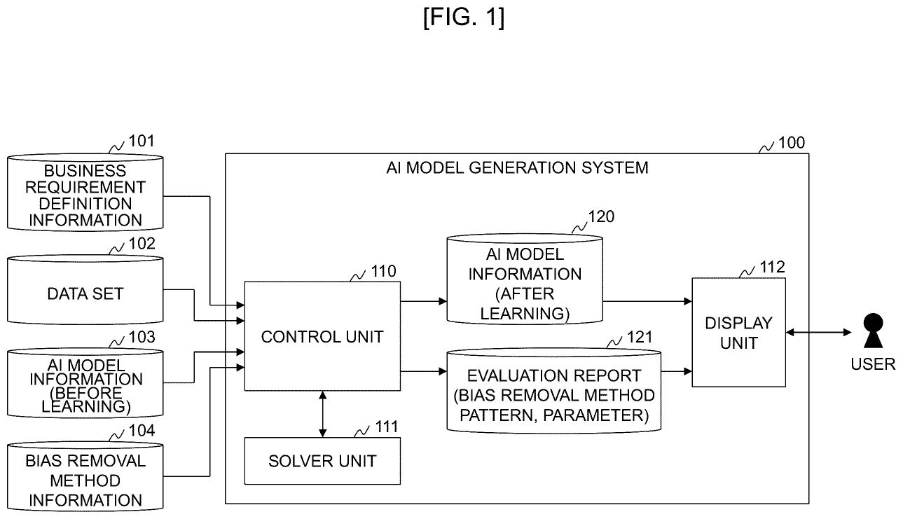

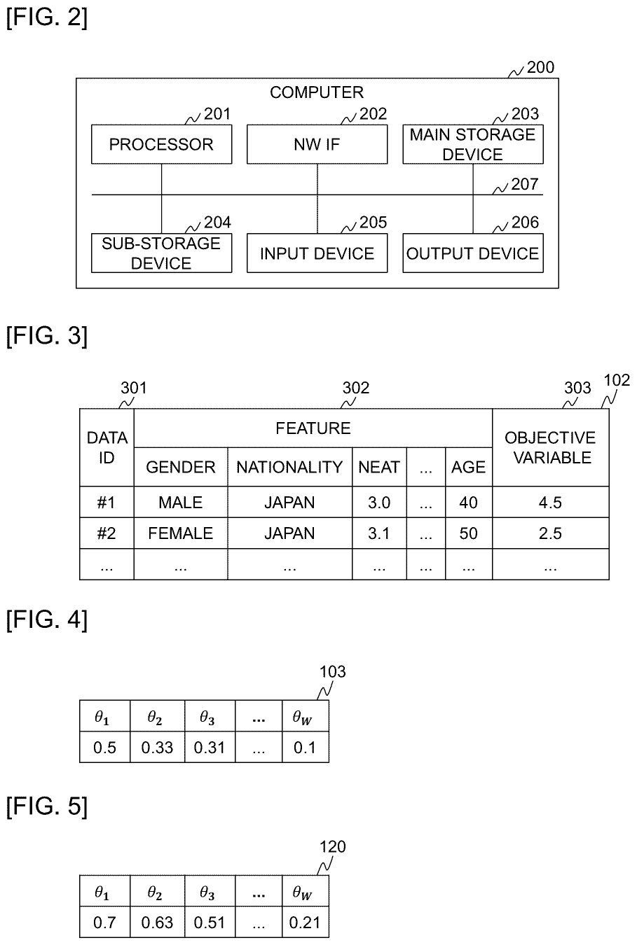

FIG. 1 is a diagram illustrating a configuration example of an AI model generation system according to Embodiment 1. FIG. 2 is a diagram illustrating an example of a hardware configuration of a computer implementing the AI model generation system according to Embodiment 1.

An AI model generation system 100 is a system that generates an AI model that satisfies a business requirement, and includes one or more computers 200. The computer 200 includes a processor 201, a network interface 202, a main storage device 203, a sub-storage device 204, an input device 205, and an output device 206. The hardware elements are connected via a bus 207.

The processor 201 executes a program stored in the main storage device 203. The processor 201 executes processing according to the program to operate as a functional unit (a module) implements a specific function. In the following description, when the processing is described with the functional unit as a subject, it indicates that the processor 201 executes a program for implementing the functional unit.

The main storage device 203 is a storage device that stores the program executed by the processor 201 and information executed by the program and is, for example, a volatile or non-volatile memory. The main storage device 203 is also used as a work area. The sub-storage device 204 is a large-capacity storage device and is, for example, a hard disk drive (HDD) and a solid state drive (SSD).

The AI model generation system 100 receives inputs of business requirement definition information 101, data set 102, AI model information 103, and bias removal method information 104.

In the present embodiment, the business requirement definition information 101 and the bias removal method information 104 are input to the AI model generation system 100 in advance. At any timing, a user selects a business requirement from the business requirement definition information 101 and inputs the data set 102 and the AI model information 103.

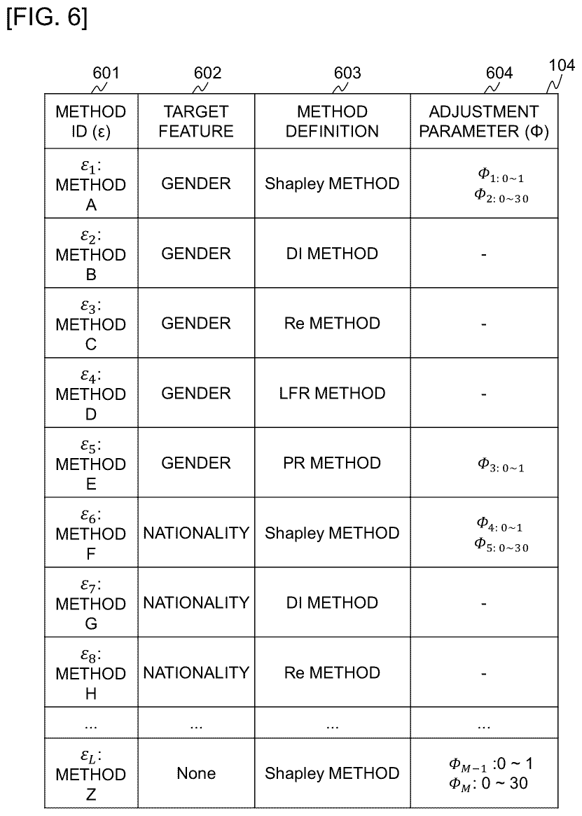

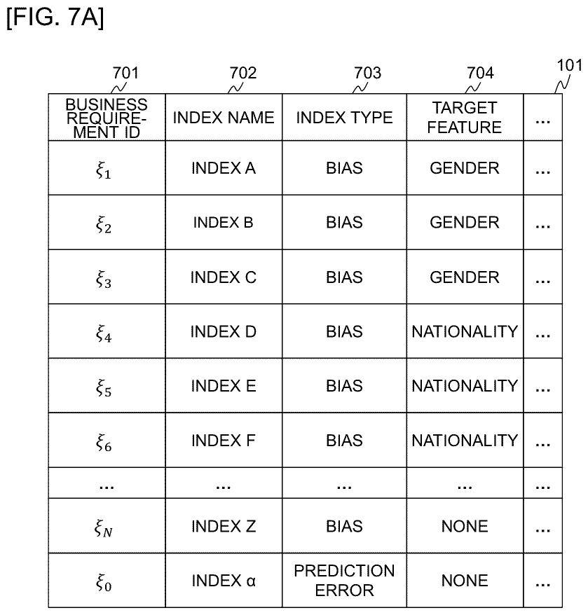

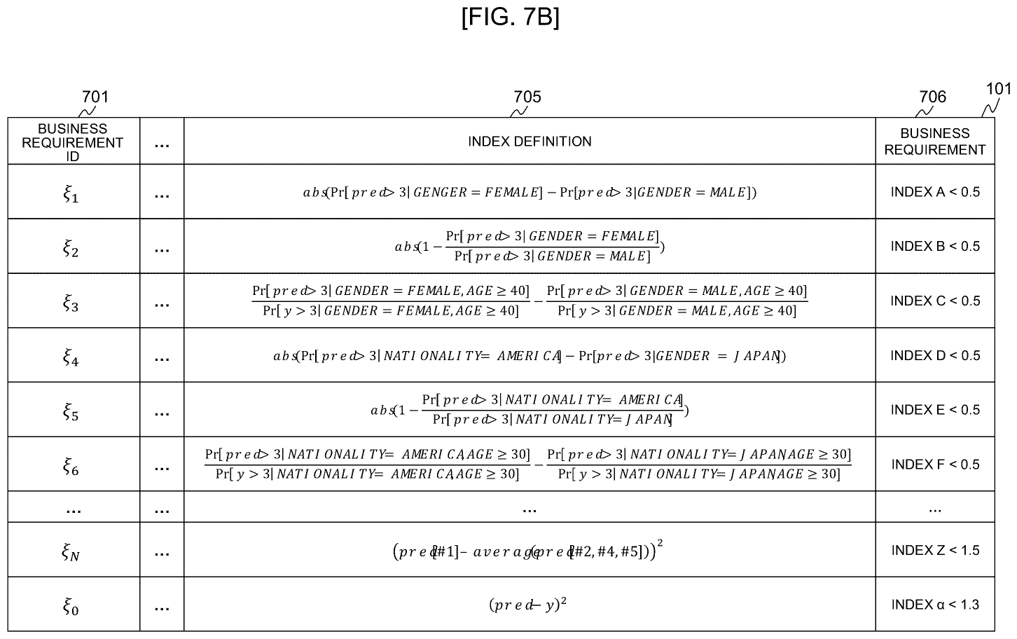

The business requirement definition information 101 is information for managing business requirements. In the present embodiment, the business requirement is defined as a condition needed to be satisfied by an evaluation index. Details of the business requirement definition information 101 will be described with reference to FIGS. 7A and 7B. The data set 102 is a set of training data used in learning processing for generating the AI model. Details of the data set 102 will be described with reference to FIG. 3. The AI model information 103 is definition information of the AI model before learning. Details of the AI model information 103 will be described with reference to FIG. 4. The bias removal method information 104 is information for managing a bias removal method. Details of the bias removal method information 104 will be described with reference to FIG. 6.

The AI model generation system 100 includes a control unit 110, a solver unit 111, and a display unit 112.

The control unit 110 receives an input from an outside and instructs the solver unit 111 to search for the bias removal method used for generating the AI model that satisfies the business requirement. The solver unit 111 generates the AI model and searches for the bias removal method for generating the AI model that satisfies the business requirement. The solver unit 111 transmits the AI model information 120, a combination of the bias removal methods, an application order, and an adjustment parameter as a processing result. The adjustment parameter is a parameter for adjusting a degree of bias removal.

In the following description, the combination of the bias removal methods in which the application order is determined is referred to as a “bias removal method pattern”.

When receiving the processing result, the control unit 110 generates an evaluation report 121 including the bias removal method pattern and the adjustment parameter, and presents the AI model information 120 and the evaluation report 121 to the user via the display unit 112.

Regarding functional units included in the AI model generation system 100, a plurality of functional units may be integrated into one functional unit, or one functional unit may be divided into a plurality of functional units for each function.

FIG. 3 is a diagram illustrating an example of a data structure of the data set 102 according to Embodiment 1.

The data set 102 stores the training data including a data ID 301, a feature 302, and an objective variable 303. In FIG. 3, one entry corresponds to one piece of training data.

The feature 302 stores values of a plurality of items (features) representing features of a target. When a person is a target, age, sex, nationality, and the like are the features. The objective variable 303 stores predicted values in inference events. For example, a probability, a profit, a degree of importance, and the like are stored as predicted values.

FIG. 4 is a diagram illustrating an example of a data structure of the AI model information 103 according to Embodiment 1. FIG. 5 is a diagram illustrating an example of a data structure of the AI model information 120 according to Embodiment 1.

The AI model information 103 and the AI model information 120 include values of parameters for defining the AI model. The AI model is, for example, a deep neural network (DNN). The AI model information 103 may include information indicating a structure of the AI model and the like.

FIG. 6 is a diagram illustrating an example of a data structure of the bias removal method information 104 according to Embodiment 1.

The bias removal method information 104 stores entries including a method ID 601, a target feature 602, a method definition 603, and an adjustment parameter 604. One entry is present for one bias removal method.

The method ID 601 is a field in which an ID of the bias removal method is stored. The target feature 602 is a field in which information on a feature of a bias removal target is stored. For example, a name of the feature is stored.

The method definition 603 is a field in which information on the bias removal method is stored. In the present embodiment, a name of the bias removal method is described for simplicity of description, but in practice, program codes and the like for implementing the bias removal method are stored.

The adjustment parameter 604 is a field in which the adjustment parameter in the bias removal method is stored. The adjustment parameter 604 of the bias removal method having no adjustment parameter is blank.

The Shapley method and the PR method are known as the bias removal method having the adjustment parameter. The Shapley method is a method of correcting the feature by using the adjustment parameter and a degree of contribution of the feature with respect to the predicted value. The PR method is a method disclosed in Non Patent Literature 4.

FIGS. 7A and 7B are diagrams illustrating an example of a data structure of the business requirement definition information 101 according to Embodiment 1. Due to space limitations in the drawing, the business requirement definition information 101 is divided into two parts.

The business requirement definition information 101 stores entries including a business requirement ID 701, an index name 702, an index type 703, a target feature 704, an index definition 705, and a business requirement 706. One entry is present for one business requirement.

The business requirement ID 701 is a field in which an ID of the business requirement is stored. The index name 702 is a field in which a name of an index is stored. The index type 703 is a field in which a type of the index is stored. In the case of an index (a bias index) for evaluating a degree of bias removal, “bias” is stored in the index type 703, and in the case of an index (a prediction accuracy index) for evaluating the prediction accuracy, a “prediction error” is stored in the index type 703. The target feature 704 is a field in which the information on the feature of the bias removal target is stored. When there is no feature of a specific bias removal target, the target feature 704 is blank.

The index definition 705 is a field in which a definition (a calculation method) of an index is stored. The business requirement 706 is a field in which a condition needed to be satisfied by the index, that is, the business requirement is stored. In Embodiment 1, a business requirement whose optimal value is 0 is set.

In the following description, a business requirement related to the bias index is referred to as a first business requirement, and a business requirement related to the prediction accuracy index is referred to as a second business requirement.

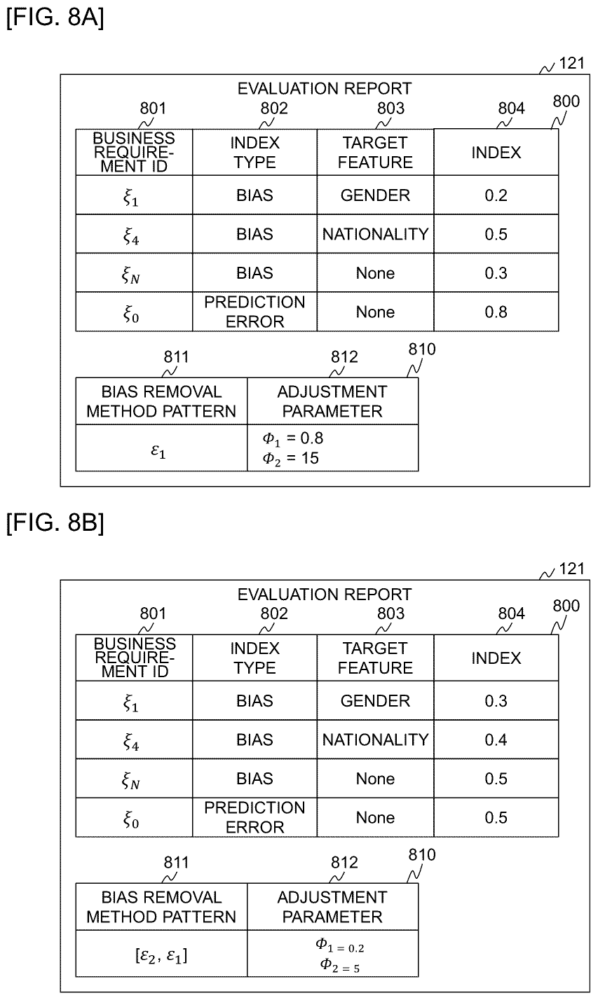

FIGS. 8A and 8B are diagrams illustrating examples of a data structure of the evaluation report 121 according to

### Embodiment 1

The evaluation report 121 includes business requirement evaluation information 800 and bias removal method pattern information 810.

The business requirement evaluation information 800 is information for managing evaluation for the business requirement. The business requirement evaluation information 800 stores entries including a business requirement ID 801, an index type 802, a target feature 803, and an index 804. One entry is present for one business requirement. The business requirement evaluation information 800 includes entries as many as the number of business requirements specified by the user.

The business requirement ID 801, the index type 802, and the target feature 803 are the same fields as the business requirement ID 701, the index type 703, and the target feature 704. The index 804 is a field in which a value of the index is stored.

The bias removal method pattern information 810 is information for managing the bias removal method pattern. The bias removal method pattern information 810 stores entries including a bias removal method pattern 811 and an adjustment parameter 812.

The bias removal method pattern 811 is a field in which the bias removal method pattern is stored. A bias removal method pattern [ε₁, ε₂] stored in the bias removal method pattern 811 in FIG. 8B represents a bias removal method pattern in which ε₁ is applied first and then ε₂ is applied.

The adjustment parameter 812 is a field in which a value of the adjustment parameter of the bias removal method included in the bias removal method pattern is stored.

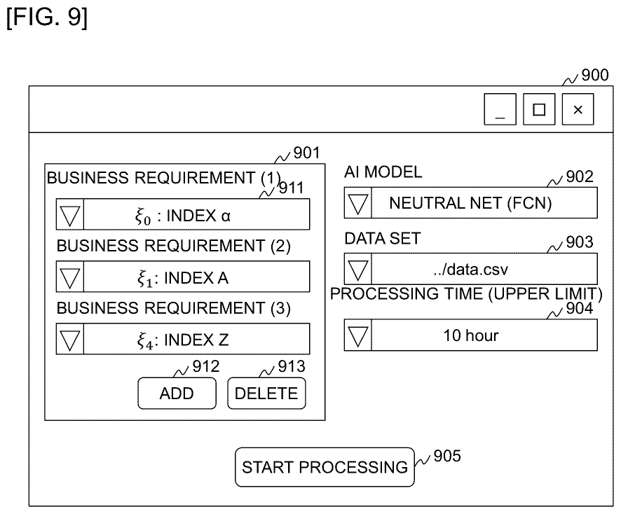

Next, processing executed by the AI model generation system 100 will be described. FIG. 9 is a diagram illustrating an example of an input screen presented by the AI model generation system 100 according to Embodiment 1.

To instruct the generation of the AI model, the user accesses the AI model generation system 100. Upon receiving the access, the AI model generation system 100 displays an input screen 900.

The input screen 900 includes an input region 901, input fields 902, 903, and 904, and an operation button 905.

The input region 901 is a region for inputting the business requirements. The input region 901 includes an input field 911 and operation buttons 912 and 913. The input field 911 is a field in which the business requirement is stored. The operation button 912 is an operation button for adding the input field 911. The operation button 913 is an operation button for deleting the input field 911. In the following description, a set of a plurality of business requirements specified by the user is referred to as a business requirement pattern.

The input field 902 is a field in which the AI model information 103 of the AI model to be generated is input. The input field 903 is a field in which the data set 102 to be used is input. The input field 904 is a field in which an upper limit value of a processing time for generating the AI model is input. The operation button 905 is an operation button for instructing the AI model generation system 100 to start the processing.

When the operation button 905 is operated, a generation request is input to the AI model generation system 100 together with information on the plurality of business requirements, the data set 102, and the AI model information 103. The second business requirement and at least one first business requirement are selected.

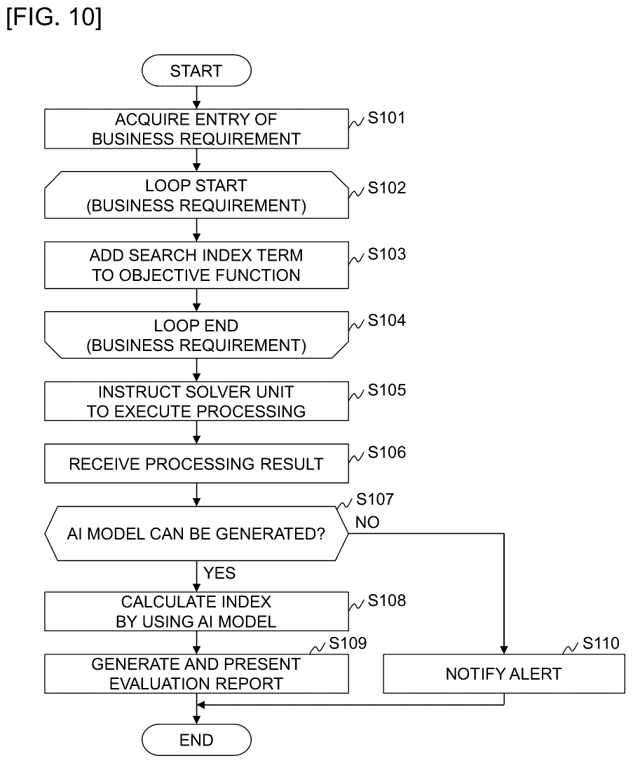

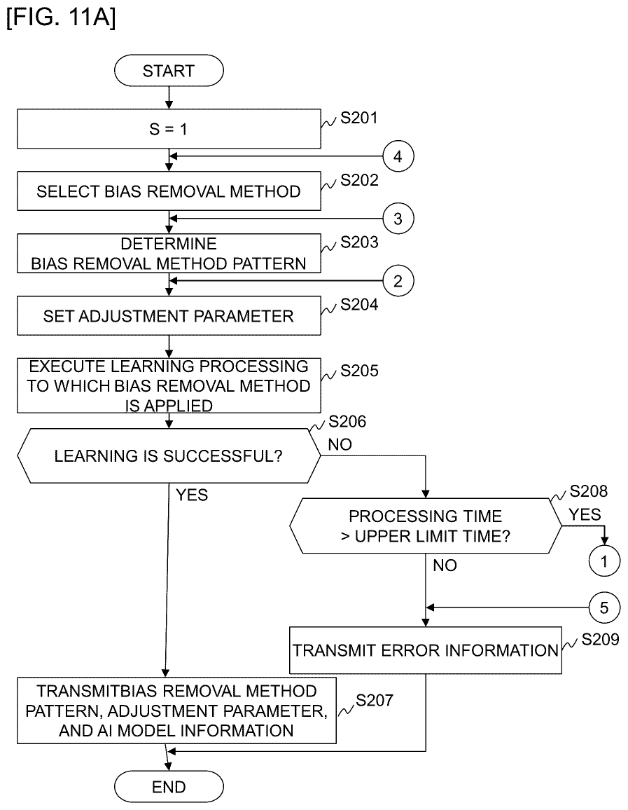

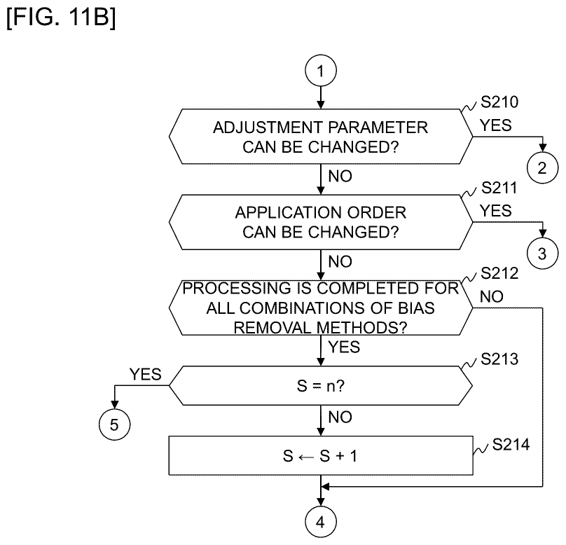

FIGS. 10, 11A, and 11B are flowcharts illustrating examples of the processing executed by the AI model generation system 100 according to Embodiment 1.

First, processing executed by the control unit 110 will be described with reference to FIG. 10. When the generation request is received, the control unit 110 reads an entry of the business requirement specified by the user from the business requirement definition information 101 (step S101) and starts loop processing of the business requirement (the first business requirement) (step S102). The control unit 110 selects one first business requirement from the business requirement pattern.

The control unit 110 adds a term related to the first business requirement to an objective function used in the learning processing wherein the objective function is a function for calculating the prediction accuracy index. For example, it is conceivable for the control unit 110 to add a term obtained by adding a weight to a bias index corresponding to the first business requirement.

The control unit 110 determines whether the processing is completed for all the business requirements (step S104).

If the processing is not completed for all the business requirements, the control unit 110 returns to step S102. If the processing is completed for all the business requirements, the control unit 110 proceeds to step S105.

When the loop processing is ended, the objective function is deformed, for example, as in Equation (1).

$$L ( ε , Φ ) = {ξ}_{0} ( ε , Φ ) + {\sum }_{k ∈ U}^{n} {w}_{k} * max \{ {ξ}_{k} ( ε , Φ ) - {z}_{k} , 0 \} \qquad ( 1 )$$

wherein L(ε, φ) is the objective function. A first term on the right side is a term relating to the prediction accuracy index. A general objective function is defined only from the first term. A second term on the right side is a term relating to the bias index. Wₖ represents a weight, ξₖ (ε, Φ) represents a bias index, and zₖ represents a threshold. k represents identification information of the bias index. U represents a set of the identification information of the bias index selected by the user. n represents the number of bias indexes selected by the user. (ε, Φ) represents that the bias removal method is applied.

In the present embodiment, learning is performed as an optimization problem with limiting conditions, in which parameters of the AI model are determined to minimize the objective function. When the objective function is minimum, it is expected that the value of the index is also a value close to 0. That is, it is expected that the first business requirement and the second business requirement are satisfied.

In step S105, the control unit 110 instructs the solver unit 111 to execute search processing (step S105). At this time, the control unit 110 notifies the solver unit 111 of the objective function, the calculation method of the index (the index definition 705), and the business requirement (the business requirement 706). Then, the control unit 110 waits for a response from the solver unit 111.

When receiving the processing result from the solver unit 111 (step S106), the control unit 110 determines whether the AI model can be generated (step S107).

If the AI model cannot be generated, the control unit 110 notifies an alert via the display unit 112 (step S110).

If the AI model can be generated, the control unit 110 calculates an index for each business requirement by using the AI model (step S108).

The control unit 110 generates the evaluation report 121 and presents the evaluation report 121 via the display unit 112 (step S109).

Next, the search processing executed by the solver unit 111 will be described. The solver unit 111 initializes a variable S to 1 (step S201). The variable S is a variable representing the number of bias removal methods.

The solver unit 111 selects S bias removal methods (step S202). In the first processing, a bias removal method is selected at random. In the second and subsequent processing, a bias removal method different from the previous bias removal method is selected.

The solver unit 111 determines the application order of the selected bias removal methods to determine the bias removal method pattern (step S203).

The solver unit 111 sets a value of the adjustment parameter of the selected bias removal method (step S204). In the first processing, the value of the adjustment parameter of the selected bias removal method is set at random. In the second and subsequent processing, a value different from the previous value is set. When the selected bias removal method is only a bias removal method having no adjustment parameter, the processing of step S203 is not executed.

The solver unit 111 may employ a search method in which a maximum value that the adjustment parameter can take is set as an initial value of the adjustment parameter and the adjustment parameter is updated to a small value when the learning is not successful. In the case of this search method, since the influence of the bias removal method is increased, the prediction accuracy may be reduced, whereas a possibility of satisfying the business requirement is increased. Therefore, it is expected that learning efficiency is improved.

The solver unit 111 executes learning processing to which the selected bias removal method is applied (step S205). In the learning processing, the AI model that minimizes the objective function and satisfies the first business requirement and the second business requirement is generated. A known learning processing of the AI model may be used.

The solver unit 111 determines whether the learning is successful (step S206). In the present embodiment, the solver unit 111 determines that the learning is successful when the first business requirement and the second business requirement are satisfied and the value of the objective function is smaller than the threshold.

It may be determined that the learning is successful when the first business requirement and the second business requirement are satisfied and a state in which the value of the objective function is smaller than a predetermined value continues.

If the learning is successful, the solver unit 111 transmits the bias removal method pattern, the adjustment parameter, and the AI model information 120 to the control unit 110 as the response (step S207). Then, the solver unit 111 ends the search processing.

If the learning is not successful, the solver unit 111 determines whether the processing time is larger than an upper limit time (step S208).

If the processing time is larger than the upper limit time, the solver unit 111 transmits error information to the control unit 110 as the response (step S209). Then, the solver unit 111 ends the search processing.

If the processing time is equal to or less than the upper limit time, the solver unit 111 determines whether the adjustment parameter can be changed (step S210). That is, it is determined whether the processing is executed in all parameter ranges.

If the adjustment parameter can be changed, the solver unit 111 returns to step S204.

If the adjustment parameter cannot be changed, the solver unit 111 determines whether the application order of the bias removal method can be changed (step S211). That is, it is determined whether the processing is executed in all application orders.

If the application order of the bias removal method can be changed, the solver unit 111 returns to step S203.

If the application order of the bias removal method cannot be changed, the solver unit 111 determines whether the processing is completed for all the combinations of the bias removal methods (step S212).

If the processing is not completed for all the combinations of the bias removal methods, the solver unit 111 returns to step S202.

If the processing is completed for all the combinations of the bias removal methods, the solver unit 111 determines whether the value of the variable S is n (step S213). n is the number of bias indexes selected by the user.

If the value of the variable S is n, the solver unit 111 transmits the error information to the control unit 110 as the response (step S209). Then, the solver unit 111 ends the search processing.

If the value of the variable S is not n, the solver unit 111 sets a value obtained by adding 1 to the variable S as a new value of the variable S (step S214). Then, the solver unit 111 returns to step S202.

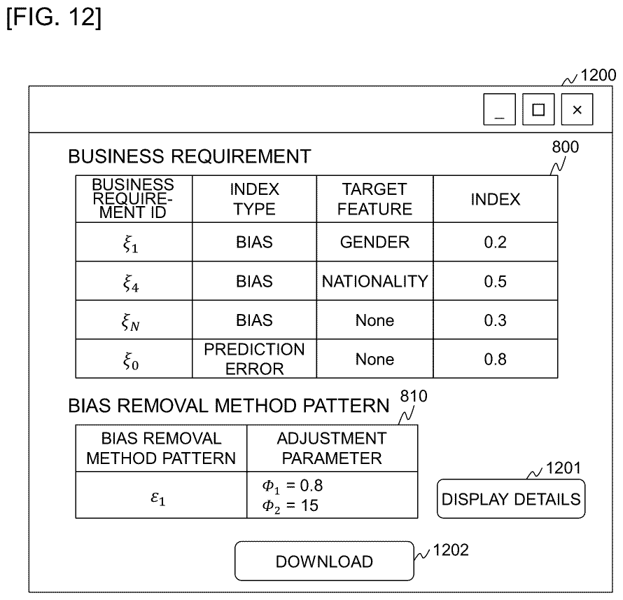

FIG. 12 is a diagram illustrating an example of an output screen presented by the AI model generation system 100 according to Embodiment 1.

An output screen 1200 displays the business requirement evaluation information 800 and the bias removal method pattern information 810. The output screen 1200 includes operation buttons 1201 and 1202. The operation button 1201 is an operation button for displaying details of the bias removal method included in the bias removal method pattern. The operation button 1202 is an operation button for downloading the AI model information 120.

As described above, the AI model generation system 100 can comprehensively search for the bias removal method pattern and the adjustment parameter for generating the bias-removed AI model with high prediction accuracy.

The number of outputs of the evaluation report 121 can be freely set. In this case, the solver unit 111 of the AI model generation system 100 continues the search until a combination of bias removal methods and a combination of adjustment parameters become specified numbers until the evaluation report 121 is generated.

According to Embodiment 1, it is possible to present, to the user, the information on the bias removal method for generating the AI model that satisfies the specified business requirement. In addition, the user can acquire and use the AI model that satisfies the specified business requirement.

### Embodiment 2

In Embodiment 2, the AI model generation system 100 converts an index according to an optimization problem to be handled. Hereinafter, Embodiment 2 will be described focusing on differences from Embodiment 1.

A functional configuration of the AI model generation system 100 according to Embodiment 2 is the same as that of Embodiment 1. Data structures of information held by the AI model generation system 100 according to Embodiment 2 are the same as those of Embodiment 1. However, in Embodiment 2, business requirements in the business requirement definition information 101 are partially different.

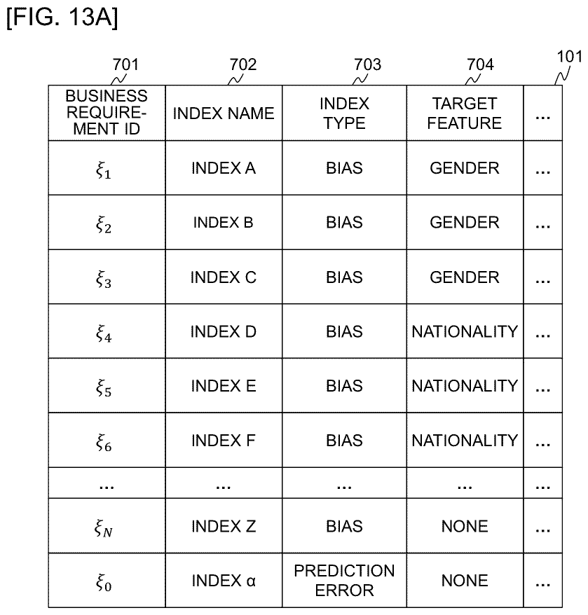

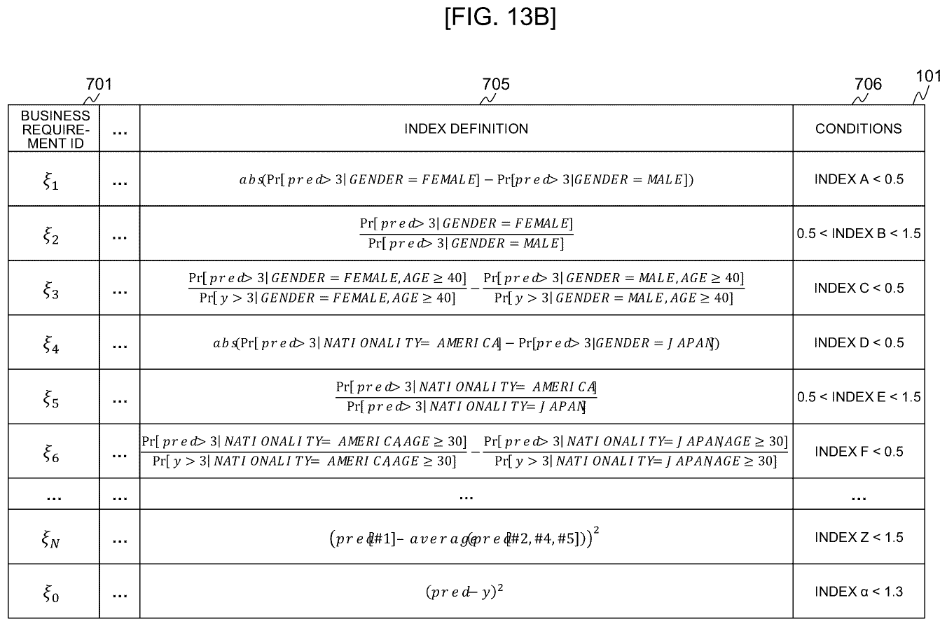

FIGS. 13A and 13B are diagrams illustrating an example of a data structure of the business requirement definition information 101 according to Embodiment 2. Due to space limitations in the drawing, the business requirement definition information 101 is divided into two parts.

Embodiment 1 is performed by handling the optimization problem with limiting conditions, in which parameters of the AI model are determined to minimize the objective function. Therefore, it is assumed that the optimal value of the business requirement is 0.

However, in FIGS. 13A and 13B, business requirements (business requirements of an index B and an index E) whose optimal value is not 0 are set. Therefore, in Embodiment 2, the index and the business requirement are converted according to the optimization problem handled by the AI model generation system 100. As a conversion method of the index, for example, the following conversion methods are conceivable. abs ( ) represents an ABS function.
(Conversion 1): abs (median of index-index)
(Conversion 2): (index)−1
(Conversion 3): abs (max (index, 0)

The conversion 1 is applied when a range of values is set as a condition. The conversion 2 is applied when the maximization of the value is set as a condition. The conversion 3 is applied when the minimization of the value is set as a condition.

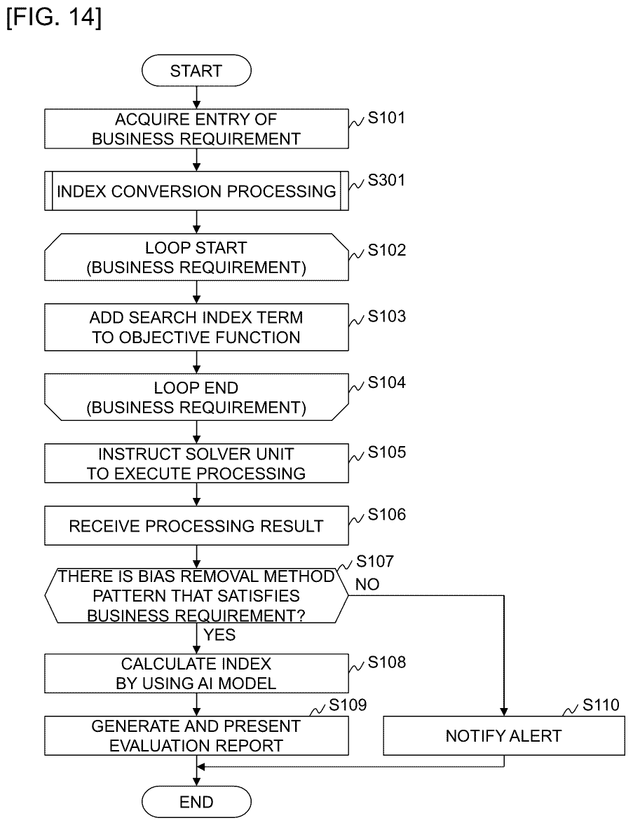

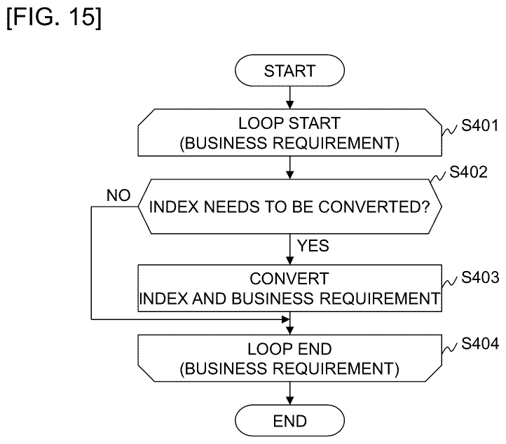

FIG. 14 is a flowchart illustrating an example of processing executed by the AI model generation system 100 according to Embodiment 2. FIG. 15 is a flowchart illustrating an example of index conversion processing executed by the control unit 110 according to Embodiment 2.

When receiving a generation request, the control unit 110 reads an entry of a business requirement specified by a user from the business requirement definition information 101 (step S101) and executes the index conversion processing (step S301). Then, the control unit 110 proceeds to step S102. The processing from step S102 to step S110 is the same as the processing described in Embodiment 1.

Next, the index conversion processing will be described. The control unit 110 starts loop processing of the business requirement (step S401). The control unit 110 selects one business requirement from the business requirement pattern.

The control unit 110 determines whether the index needs to be converted based on the business requirement (step S402). When a condition that the optimal value is not 0 is set, the control unit 110 determines that the index needs to be converted.

If the index does not need to be converted, the control unit 110 proceeds to step S404.

If the index needs to be converted, the control unit 110 converts the index and the business requirement (step S403). Then, the control unit 110 proceeds to step S404.

Specifically, the control unit 110 selects conversion method according to the business requirement and converts the index and the business requirement with the selected conversion method. The control unit 110 reflects a conversion result in the entry of the selected business requirement.

The control unit 110 determines whether the processing is completed for all the business requirements (step S404).

If the processing is not completed for all the business requirements, the control unit 110 returns to step S401. If the processing is completed for all the business requirements, the control unit 110 ends the index conversion processing.

Search processing executed by the solver unit 111 according to Embodiment 2 is the same as the processing described in Embodiment 1.

According to Embodiment 2, the user can freely define the business requirement. Accordingly, it is possible to reduce the burden required to set the business requirement.

### Embodiment 3

In Embodiment 3, when a bias removal method pattern and an adjustment parameter that satisfy a specified business requirement are not found, the AI model generation system 100 changes the business requirement to a business requirement similar to the specified business requirement and performs the search. Hereinafter, Embodiment 3 will be described focusing on differences from Embodiment 1.

In the following description, a business requirement pattern including business requirements specified by the user is referred to as an initial business requirement pattern.

A functional configuration of the AI model generation system 100 according to Embodiment 3 is the same as that of Embodiment 1. Data structures of information held by the AI model generation system 100 according to Embodiment 3 are the same as those of Embodiment 1.

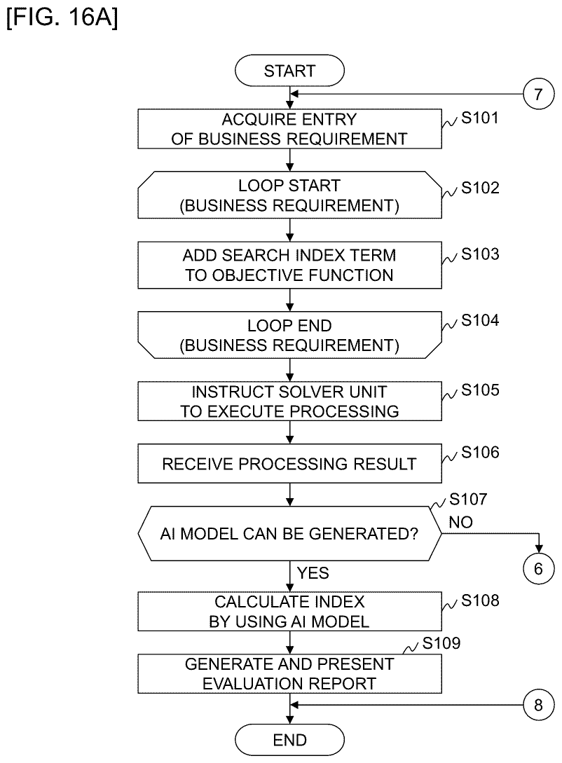

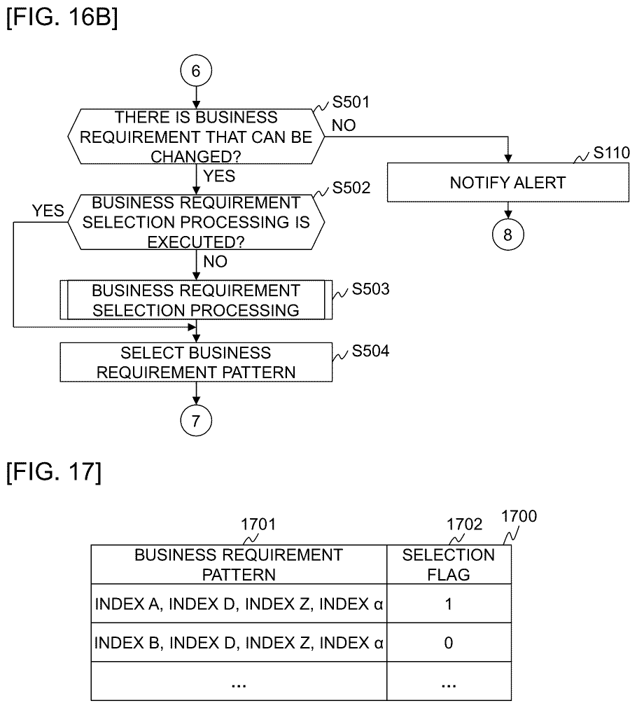

FIGS. 16A and 16B are flowcharts illustrating an example of processing executed by the AI model generation system 100 according to Embodiment 3.

The processing from step S101 to step S107 is the same as the processing described in Embodiment 1.

In step S107, if it is determined that the AI model cannot be generated, the control unit 110 determines whether there is a business requirement that can be changed among the business requirements included in the initial business requirement pattern (step S501).

Specifically, the control unit 110 refers to the business requirement definition information 101 to determine whether there is another business requirement whose target feature matches the target feature of the business requirement for each of the business requirements included in the initial business requirement pattern.

When the business requirement cannot be changed, the control unit 110 notifies an alert via the display unit 112 (step S110).

When the business requirement can be changed, the control unit 110 determines whether business requirement selection processing is executed (step S502).

Specifically, the control unit 110 determines whether a business requirement pattern list 1700 is generated. If the business requirement pattern list 1700 is generated, the control unit 110 determines that the business requirement selection processing is executed.

Here, the business requirement pattern list 1700 will be described. FIG. 17 is a diagram illustrating an example of the business requirement pattern list 1700 according to Embodiment 3.

The business requirement pattern list 1700 stores entries including a business requirement pattern 1701 and a selection flag 1702. One entry is present for one business requirement pattern.

The business requirement pattern 1701 is a field in which the business requirement pattern is stored. The selection flag 1702 stores a flag indicating whether the business requirement pattern is selected. When the business requirement pattern is selected, “1” is stored in the selection flag 1702, and when the business requirement pattern is not selected, “0” is stored in the selection flag 1702.

Return to the description of FIG. 16B. In step S502, if the business requirement selection processing is executed, the control unit 110 proceeds to step S504.

If the business requirement selection processing is not executed, the control unit 110 executes the business requirement selection processing (step S503) and then proceeds to step S504.

In step S504, the control unit 110 selects one business requirement pattern from the business requirement pattern list 1700 (step S504) and then returns to step S101. At this time, the control unit 110 updates the selection flag 1702 of the selected business requirement pattern to “1”.

The processing of step S108 is the same as that according to Embodiment 1. The processing of step S109 when the AI model is generated in the initial business requirement pattern is the same as that according to Embodiment 1. When the AI model is generated in a business requirement pattern different from the initial business requirement pattern, the processing of step S109 is partially different.

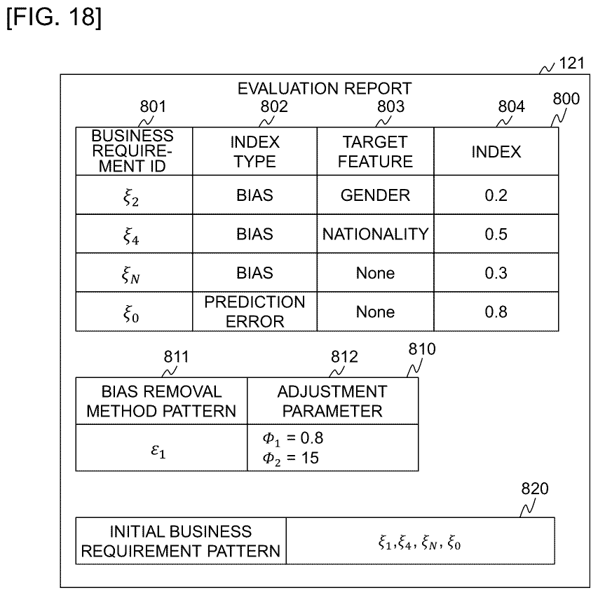

FIG. 18 is a diagram illustrating an example of a data structure of the evaluation report 121 according to Embodiment 3. FIG. 18 illustrates the evaluation report 121 generated when the AI model is generated in a business requirement pattern different from the initial business requirement pattern. The evaluation report 121 includes initial business requirement pattern information 820.

When the AI model is generated in a business requirement pattern different from the initial business requirement pattern, the control unit 110 generates the evaluation report 121 including the initial business requirement pattern information 820.

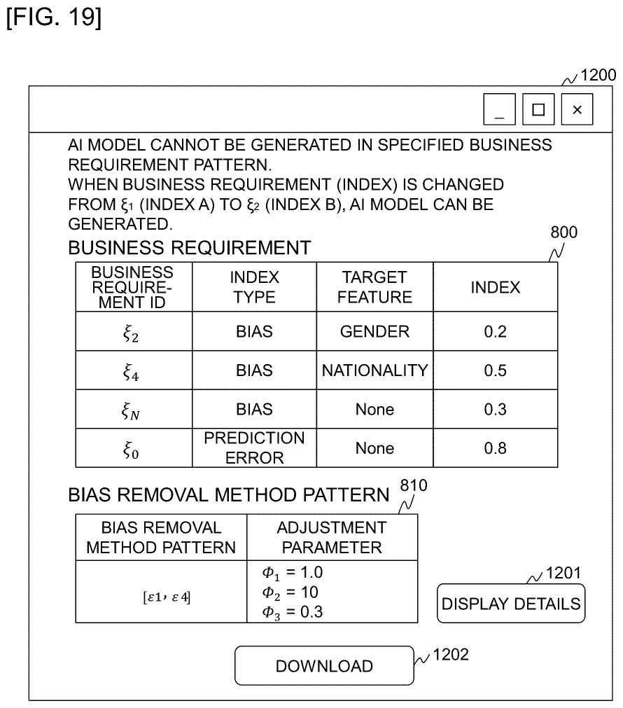

In this case, the output screen 1200 as illustrated in FIG. 19 is displayed. In the output screen 1200, information on the used business requirement pattern that indicates that the AI model cannot be generated in the initial business requirement pattern is added.

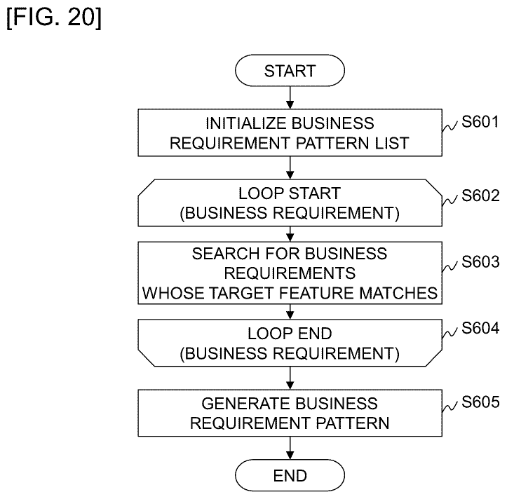

FIG. 20 is a flowchart illustrating an example of the business requirement selection processing executed by the AI model generation system 100 according to Embodiment 3.

The control unit 110 initializes the business requirement pattern list 1700 (step S601).

Specifically, the control unit 110 generates an empty business requirement pattern list 1700 and adds one entry to the business requirement pattern list 1700. The control unit 110 sets the initial business requirement pattern in the business requirement pattern 1701 of the added entry and sets “1” in the selection flag 1702.

The control unit 110 starts loop processing of the business requirement (step S602). One business requirement is selected from the initial business requirement pattern.

The control unit 110 refers to the business requirement definition information 101 to search for another business requirement whose target feature is the same as the target feature of the selected business requirement (step S603). The control unit 110 stores a search result in a work area.

The control unit 110 determines whether the processing is completed for all the business requirements (step S604).

If the processing is not completed for all the business requirements, the control unit 110 returns to step S602.

When the processing is completed for all the business requirements, the control unit 110 generates a business requirement pattern in which at least one business requirement of the initial business requirement pattern is replaced (step S605). The control unit 110 adds entries of the number of generated business requirement patterns to the business requirement pattern list 1700, sets the business requirement pattern in the business requirement pattern 1701 of each entry, and sets “0” in the selection flag 1702 of each entry.

Search processing executed by the solver unit 111 according to Embodiment 3 is the same as the processing described in Embodiment 1.

According to Embodiment 3, it is possible to substitute similar business requirements to present an alternative business requirement, the bias removal method, and the AI model.

### Embodiment 4

In Embodiment 4, the AI model generation system 100 derives an adjustment parameter for a bias removal method having no adjustment parameter. Hereinafter, Embodiment 4 will be described focusing on differences from Embodiment 1.

A functional configuration of the AI model generation system 100 according to Embodiment 4 is the same as that of Embodiment 1. Data structures of information held by the AI model generation system 100 according to Embodiment 4 are the same as those of Embodiment 1.

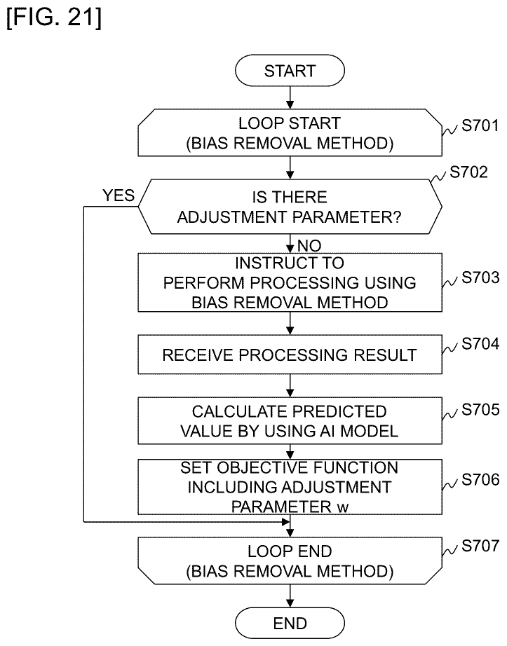

FIG. 21 is a flowchart illustrating an example of adjustment parameter setting processing executed by the AI model generation system 100 according to Embodiment 4. The AI model generation system 100 executes the adjustment parameter setting processing to be described later in advance.

The control unit 110 starts loop processing of a bias removal method (step S701). The control unit 110 selects one bias removal method (entry) from the bias removal method information 104.

The control unit 110 determines whether there is an adjustment parameter in the selected bias removal method (step S702).

If there is an adjustment parameter in the selected bias removal method, the control unit 110 proceeds to step S707.

If there is no adjustment parameter in the selected bias removal method, the control unit 110 instructs the solver unit 111 to execute processing using the selected bias removal method (step S703). Then, the control unit 110 waits for a response from the solver unit 111.

When receiving a processing result from the solver unit 111 (step S704), the control unit 110 calculates a predicted value for training data by using the generated AI model (step S705).

The control unit 110 sets an objective function including an adjustment parameter w by using the predicted value and an objective variable (step S706), and then proceeds to step S707. Specifically, an objective function illustrated in Equation (2) is set.

$$L = {w ( y - {y}_{pred} )}^{2} - ( 1 - w ) {( {y}_{c a r} - {y}_{p r e d} )}^{2} \qquad ( 2 )$$

wherein Ycar represents a predicted value calculated by using the AI model learned using the bias removal method selected in step S701. Ypred represents a predicted value calculated in learning processing executed when an execution instruction of step S105 is received.

The adjustment parameter w is a parameter for adjusting whether a prediction result is close to a predicted value before the bias removal method is applied or a predicted value after the bias removal method is applied. The adjustment parameter w is a parameter for adjusting a degree of bias removal, that is, functions as an adjustment parameter.

The control unit 110 sets the adjustment parameter w in the adjustment parameter 604 of the bias removal method selected from the bias removal method information 104, wherein w ranges from 0 to 1.

In step S707, the control unit 110 determines whether the processing is completed for all the bias removal methods (step S707).

If the processing is not completed for all the bias removal methods, the control unit 110 returns to step S701. If the processing is completed for all the bias removal methods, the control unit 110 ends the adjustment parameter setting processing.

The processing of generating the evaluation report 121 according to Embodiment 4 is the same as that of Embodiment 1.

According to Embodiment 4, a search range can be widened by introducing the adjustment parameter. Accordingly, a more appropriate bias removal method and AI model can be presented.

### Embodiment 5

In Embodiment 5, the AI model generation system 100 adjusts an adjustment parameter based on a correlation between a bias removal method and an index. Hereinafter, Embodiment 5 will be described focusing on differences from Embodiment 1.

A functional configuration of the AI model generation system 100 according to Embodiment 5 is the same as that of Embodiment 1. Data structures of information held by the AI model generation system 100 according to Embodiment 5 is the same as those of Embodiment 1.

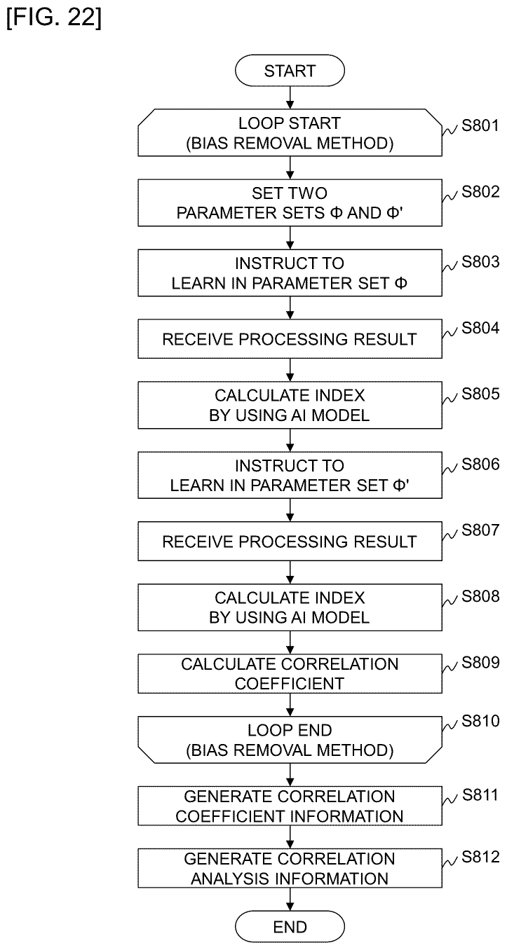

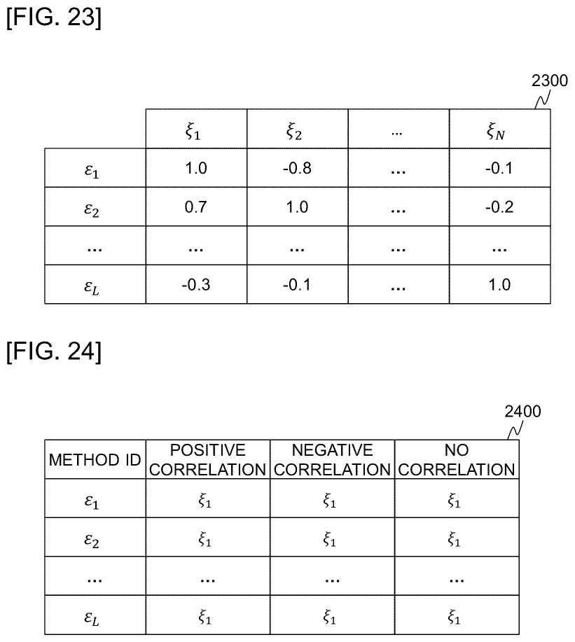

FIG. 22 is a flowchart illustrating an example of correlation analysis processing executed by the AI model generation system 100 according to Embodiment 5. FIG. 23 is a diagram illustrating an example of correlation coefficient information generated by the AI model generation system 100 according to Embodiment 5. FIG. 24 is a diagram illustrating an example of correlation analysis information generated by the AI model generation system 100 according to Embodiment 5.

The AI model generation system 100 executes the correlation analysis processing to be described later in advance.

The control unit 110 starts loop processing of the bias removal method (step S801). The control unit 110 refers to the bias removal method information 104 to select one bias removal method.

The control unit 110 sets two adjustment parameter sets of the selected bias removal method (step S802). The adjustment parameter set represents a set of adjustment parameters. For example, when there are two adjustment parameters Φ₁ and Φ₂ in the bias removal method, the control unit 110 sets an adjustment parameter set (Φ₁, Φ₂) and an adjustment parameter set (Φ′₁, Φ′₂).

The control unit 110 instructs the solver unit 111 to execute processing using the bias removal method according to one adjustment parameter set (step S803). Then, the control unit 110 waits for a response from the solver unit 111.

When receiving a processing result from the solver unit 111 (step S804), the control unit 110 calculates all the indexes defined in the business requirement definition information 101 by using the AI model (step S805).

The control unit 110 instructs the solver unit 111 to execute processing using a bias removal method according to the other adjustment parameter set (step S806). Then, the control unit 110 waits for a response from the solver unit 111.

When receiving a processing result from the solver unit 111 (step S807), the control unit 110 calculates all the indexes defined in the business requirement definition information 101 by using the AI model (step S808).

The control unit 110 calculates a correlation coefficient between the bias removal method and the index based on a change amount of the indexes calculated in step S805 and step S807 and a change amount of the adjustment parameter set (step S809).

The control unit 110 determines whether the processing is completed for all the bias removal methods (step S810).

If the processing is not completed for all the bias removal methods, the control unit 110 returns to step S801.

If the processing is completed for all the bias removal methods, the control unit 110 generates correlation coefficient information 2300 as illustrated in FIG. 23 based on a calculation result (step S811). The correlation coefficient information 2300 is information in a matrix form in which the bias removal methods are rows and bias indexes are columns. Cells store the correlation coefficients.

The control unit 110 determines the correlation between the bias removal method and the index based on the correlation coefficient and generates correlation analysis information 2400 (step S812). For example, the control unit 110 determines that the index having a correlation coefficient of +0.5 or more has a positive correlation with the bias removal method, the index having a correlation coefficient of −0.5 or less has a negative correlation with the bias removal method, and the other indexes have no correlation with the bias removal method.

The correlation analysis information 2400 stores entries including a method ID 2401, a positive correlation 2402, a negative correlation 2403, and a no correlation 2404. One entry is present for one bias removal method. The method ID 2401 is the same field as the method ID 601. The positive correlation 2402 is a field in which an index having a positive correlation with the bias removal method is stored. The negative correlation 2403 is a field in which an index having a negative correlation with the bias removal method is stored. The no correlation 2404 is a field in which an index having no correlation with the bias removal method is stored.

The processing executed by the control unit 110 to generate the evaluation report 121 that satisfies the business requirement is the same as that of Embodiment 1.

The search processing executed by the solver unit 111 is the same as that of Embodiment 1, and a processing content is partially different. Specifically, the processing content of step S204 is different.

(S204-1) The solver unit 111 identifies an index that does not satisfy the condition among the indexes calculated by using the AI model.

(S204-2) The solver unit 111 refers to the correlation analysis information 2400 to determine whether to change the adjustment parameter.

wherein it is assumed that there are indexes ξ₁, ξ₂, ξ₄, and ξ_{N} and the bias removal method pattern is only ε₁. When the index ξ₂ is larger than a threshold and has a positive correlation with the bias removal method ε₁, the index ξ₂ may satisfy the condition by reducing the adjustment parameter of the bias removal method ε₁. In contrast, when the indexes ε₁ and ξ₄ have a negative correlation with the bias removal method ε₁, the indexes ξ₁ and ξ₄ may no longer satisfy the condition by reducing the adjustment parameter of the bias removal method ε₁.

The solver unit 111 determines whether to change the adjustment parameter based on a degree of violation of the condition of the index and the correlation between the index and the selected bias removal method.

(S204-3) When determining not to change the adjustment parameter, the solver unit 111 returns to step S203.

(S204-4) When determining to change the adjustment parameter, the solver unit 111 sets the adjustment parameter based on the degree of violation of the condition of the index and the correlation between the index and the selected bias removal method.

The solver unit 111 may refer to the correlation analysis information 2400 and the previous bias removal method pattern to select the bias removal method in step S202.

According to Embodiment 5, the adjustment range of the adjustment parameter or the selection range of the bias removal method is narrowed, making it possible to search for the bias removal method and the AI model more quickly.

The invention is not limited to the embodiments described above and includes various modifications. For example, the embodiments described above are described in detail to facilitate understanding of the invention, and the invention is not necessarily limited to those including all the described configurations. A part of a configuration in each embodiment may be added to, deleted from, or replaced with another configuration.

A part or all of the configurations, functions, processing units, processing methods, and the like described above may be implemented by hardware by, for example, designing with an integrated circuit. The invention can also be implemented by a program code of software for implementing the functions of the embodiments. In this case, a storage medium storing the program code is provided to a computer, and a processor provided in the computer reads the program code stored in the storage medium. In this case, the program code read from the storage medium implements the functions of the embodiments described above by itself, and the program code itself and the storage medium storing the program code implement the invention. Examples of the storage medium for supplying such a program code include a flexible disk, a CD-ROM, a DVD-ROM, a hard disk, a solid state drive (SSD), an optical disk, a magneto-optical disk, a CD-R, a magnetic tape, a nonvolatile memory card, and a ROM.

Further, the program code for implementing the functions described in the embodiments can be implemented in a wide range of programs or script languages such as Assembler, C/C++, Perl, PHP, Python, and Java (registered trademark).

Further, the program code of software for implementing the functions of the embodiments may be distributed via a network to be stored in a storage unit such as a hard disk or a memory of a computer or a storage medium such as a CD-RW or a CD-R, and a processor provided in the computer may read and execute the program code stored in the storage unit or the storage medium.

Control lines and information lines considered to be necessary for description are illustrated in the embodiments described above, and not all control lines and information lines in a product are necessarily illustrated. All the configurations may be connected.

What is claimed is:

1. A computer system comprising:
a processor; and
a storage device connected to the processor, wherein
the storage device stores
a data set including a plurality of pieces of training data each including a plurality of features and an objective variable,
business requirement definition information for storing a plurality of pieces of business requirement data each defining a business requirement in a business using an AI model, and
bias removal method management information for storing bias removal method data in which the feature of a bias removal target and a bias removal method for removing a bias of the feature are associated,
the plurality of pieces of business requirement data include a plurality of pieces of first business requirement data including the feature of the bias removal target, a calculation method of a first index for evaluating a degree of bias removal, and a first business requirement defined by using the first index, and second business requirement data including a second index for evaluating a prediction accuracy of the AI model and a second business requirement defined by using the second index,
the processor receives an AI model generation request including information for specifying at least one of the first business requirement and the second business requirement,
executes, by using the data set, the business requirement definition information, and the bias removal method management information, search processing of searching for the bias removal method used to generate an AI model that satisfies the first business requirement and the second business requirement specified in the AI model generation request, and
generates and outputs a report including information on the used bias removal method when the AI model that satisfies the first business requirement and the second business requirement specified in the AI model generation request is generated, and
in the search processing, processing of selecting at least one of the bias removal methods and processing of executing learning processing of generating the AI model by using the selected bias removal method are repeatedly executed until the first business requirement and the second business requirement specified in the AI model generation request are satisfied.

2. The computer system according to claim 1, wherein
when a plurality of the bias removal methods are selected, the processor searches for the AI model that satisfies the first business requirement and the second business requirement specified in the AI model generation request while changing an application order of the selected plurality of bias removal methods in the search processing, and
generates the report including the application order of the bias removal methods.

3. The computer system according to claim 1, wherein
at least one piece of the bias removal method data includes an adjustment parameter for adjusting an intensity of bias removal, and
the processor searches for the AI model that satisfies the first business requirement and the second business requirement specified in the AI model generation request while changing the adjustment parameter when the bias removal method in which the adjustment parameter is present is selected in the search processing, and
generates the report including the selected bias removal method and the adjustment parameter.

4. The computer system according to claim 3, wherein
the bias removal method data in which the feature of the bias removal target is the same is stored in the bias removal method management information, and
in the search processing, the processor refers to the bias removal method management information to identify another first business requirement having the same feature as the feature of the bias removal target of the first business requirement specified in the AI model generation request when the AI model that satisfies the first business requirement and the second business requirement specified in the AI model generation request is not present, and
searches for the AI model after converting the first business requirement specified in the AI model generation request to the identified first business requirement.

5. The computer system according to claim 3, wherein
in the search processing, the processor sets a parameter for adjusting an error between a predicted value of the AI model to which the bias removal method is applied and the objective variable as the adjustment parameter when the bias removal method in which the adjustment parameter is not present is selected.

6. The computer system according to claim 3, wherein
the processor analyzes a correlation between the bias removal method and the first index and the second index, and
selects the bias removal method or adjusts the adjustment parameter based on a result of the analysis in the search processing.

7. A method for searching for a bias removal method for generating an AI model that satisfies a business requirement, the method being executed by a computer system,
the computer system including a processor and a storage device connected to the processor,
the storage device storing
a data set including a plurality of pieces of training data each including a plurality of features and an objective variable,
business requirement definition information for storing a plurality of pieces of business requirement data each defining a business requirement in a business using an AI model, and
bias removal method management information for storing bias removal method data in which the feature of a bias removal target and a bias removal method for removing a bias of the feature are associated,
the plurality of pieces of business requirement data include a plurality of pieces of first business requirement data including the feature of the bias removal target, a calculation method of a first index for evaluating a degree of bias removal, and a first business requirement defined by using the first index, and second business requirement data including a second index for evaluating a prediction accuracy of the AI model and a second business requirement defined by using the second index,
the method comprising:
a first step of receiving, by the processor, an AI generation request including information for model specifying at least one of the first business requirement and the second business requirement;
a second step of executing, by the processor, search processing of searching for the bias removal method used to generate an AI model that satisfies the first business requirement and the second business requirement specified in the AI model generation request by using the data set, the business requirement definition information, and the bias removal method management information; and
a third step of generating and outputting, by the processor, a report including information on the used bias removal method when the AI model that satisfies the first business requirement and the second business requirement specified in the AI model generation request is generated, wherein
the second step includes a step of repeatedly executing, by the processor, processing of selecting at least one of the bias removal methods and processing of executing learning processing of generating the AI model by using the selected bias removal method until the first business requirement and the second business requirement specified in the AI model generation request are satisfied.

8. The method for searching for a bias removal method according to claim 7, wherein
the second step includes a step of searching for, when a plurality of the bias removal methods are selected, the AI model that satisfies the first business requirement and the second business requirement specified in the AI model generation request while changing an application order of the plurality of selected bias removal methods by the processor, and
the third step includes a step of generating, by the processor, the report including the application order of the bias removal methods.

9. The method for searching for a bias removal method according to claim 7, wherein
at least one piece of the bias removal method data includes an adjustment parameter for adjusting an intensity of bias removal,
the second step includes a step of searching for, by the processor, the AI model that satisfies the first business requirement and the second business requirement specified in the AI model generation request while changing the adjustment parameter when the bias removal method in which the adjustment parameter is present is selected, and
the third step includes a step of generating, by the processor, the report including the selected bias removal method and the adjustment parameter.

10. The method for searching for a bias removal method according to claim 9, wherein
the bias removal method data in which the feature of the bias removal target is the same is stored in the bias removal method management information, and
the second step includes
a step of referring to, by the processor, the bias removal method management information to identify another first business requirement having the same feature as the feature of a bias removal target of the first business requirement specified in the AI model generation request when the AI model that satisfies the first business requirement and the second business requirement specified in the AI model generation request is not present, and
a step of searching for, by the processor, the AI model after converting the first business requirement specified in the AI model generation request to the identified first business requirement.

11. The method for searching for a bias removal method according to claim 9, wherein
the second step includes a step of setting, by the processor, a parameter for adjusting an error between a predicted value of the AI model to which the bias removal method is applied and the objective variable as the adjustment parameter when the bias removal method in which the adjustment parameter is not present is selected.

12. The method for searching for a bias removal method according to claim 9, further comprising:
a step of analyzing, by the processor, a correlation between the bias removal method and the first index and the second index, wherein
the second step includes a step of selecting, by the processor, the bias removal method or adjusting the adjustment parameter based on a result of the analysis.
